(19) United States
(12) Patent Application Publication
(10) Pub. No.: US 2005/0231731 A1
(43) Pub. Date: Oct. 20, 2005

(54) Systems and methods for fabricating thin films

(75) Inventor: Michael A. Beamesderfer, York, PA (US)

Correspondence Address: NASA GODDARD SPACE FLIGHT CENTER, 8800 GREENBELT ROAD, MAIL CODE 140.1, GREENBELT, MD, 20771, US

(73) Assignee: The USA as represented by the Administrator of the National Aeronautics and Space Administration

(21) Appl. No.: 11/066,654

(22) Filed: Feb. 18, 2005

Related U.S. Application Data
(60) Provisional application No. 60/546,313, filed on Feb. 18, 2004.
(60) Provisional application No. 60/546,311, filed on Feb. 18, 2004.

(51) Int. Cl. G01B 11/02

(52) U.S. Cl. 356/503

(57) ABSTRACT

Disclosed are systems and methods for depositing thin films of uniform thickness. In an exemplary system, there is a coating chamber, an optical fiber in the coating chamber, and a plate oriented to receive light from the optical fiber. The exemplary system also includes a processor configured to process a light signal reflected from a thin film layer on a substrate. The coating process is responsive to the reflected light signal received from the thin film layer.

### CROSS-REFERENCE TO RELATED APPLICATIONS

Priority is claimed under 35 U.S.C. § 119(e) from U.S. Provisional Patent Application No. 60/546,313 filed Feb. 18, 2004 for REAL-TIME PARYLENE-THICKNESS MONITORING OPTICAL SENSOR SYSTEM, the contents of which are herein incorporated by reference in their entirety. This Application further claims the benefit of Application Ser. No. 60/546,311 filed Feb. 18, 2004 for THIN FILM PARYLENE-C AS A SACRIFICIAL LAYER FOR MICROFABRICATION, the contents of which are herein incorporated by reference in their entirety.

### ORIGIN OF THE INVENTION

The invention described herein was made by an employee of the United States Government, and may be manufactured and used by or for the Government for government purposes without the payment of any royalty thereon or therefor.

### BACKGROUND OF THE INVENTION

1. Field of the Invention

This invention relates generally to systems and methods for fabricating films and, more particularly, to systems and methods for fabricating thin films by real time measurement of film thickness to permit precise control of same.

2. Description of Related Art

Certain fabrication processes deposit a layer of material over a subassembly. The quality of results typically depends on the thickness of the deposited layer. Because the deposition rate may vary with process conditions that are not precisely controlled or monitored, the resulting layer thickness may not be controlled in certain conventional processes. Traditional techniques can provide only a reasonable assurance of accuracy and cannot deposit the films at highly specified tolerances (30-0.5 microns). In order to achieve this level of accuracy, the thickness of the deposited film must be measured in real time. A further disadvantage of traditional thin film depositing techniques is the fact that minor variations in temperature, chamber pressure, dimer purity, etc., result in variations in film thickness. With some thin film applications, these minor variations can greatly affect the precision of the coating which may adversely affect the performance of the coated part. Thus, there is a need in the industry for a thin film depositing method that can deposit films within high tolerances with great accuracy.

### SUMMARY OF THE INVENTION

According to an aspect of the present invention, there is a method and system including a first substrate, and a second substrate. The method comprises depositing a first layer over the first substrate, the first layer having a first material; depositing a second layer over the first substrate, having the first layer, the second layer having a second material different than the first material; concurrently with the previous step, depositing the second layer over the second substrate, which is separate from the first layer; receiving a light signal from the second layer on the second substrate; and processing the light signal received in the previous step.

According to another aspect of the present invention, there is a system for use with a chamber. The system comprises an optical conduit; a surface, in the chamber, oriented to receive light from the optical conduit; a detector configured to process a light signal reflected from the surface; and a depositor that deposits a material in the chamber, the depositor being responsive to an output of the detector.

According to yet another aspect of the present invention, there is a deposition system for a system including a first substrate. The deposition system comprises a second substrate; means for depositing a layer over the first and second substrates; means for receiving a light signal from the layer on the second substrate; means for processing the light signal received by the previous means; and means for conditionally ending the depositing of the layer depending on a signal from the processing means.

### BRIEF DESCRIPTION OF THE DRAWINGS

References are made to the following text taken in connection with the accompanying drawings, in which:

FIG. 1 is a diagram of a fabrication system employing a preferred embodiment of the present invention.

FIGS. 2A and 2B are a flow chart showing a process performed in the exemplary system of FIG. 1.

FIG. 3 is a diagram emphasizing an optical portion of the system of FIG. 1.

FIG. 4 is a plan view emphasizing a portion of the system of FIG. 1.

FIG. 5 is a side view corresponding to a portion of FIG. 4.

FIG. 6 is a schematic diagram representing a chemical structure in the exemplary system of FIG. 1.

The accompanying drawings which are incorporated in and which constitute a part of this specification, illustrate embodiments of the invention and, together with the description, explain the principles of the invention, and additional advantages, thereof. Certain drawings are not necessarily to scale, and certain features may be shown larger than relative actual size to facilitate a clearer description of those features. Throughout the drawings, corresponding elements are labeled with corresponding reference numbers.

### DETAILED DESCRIPTION OF EXEMPLARY EMBODIMENTS

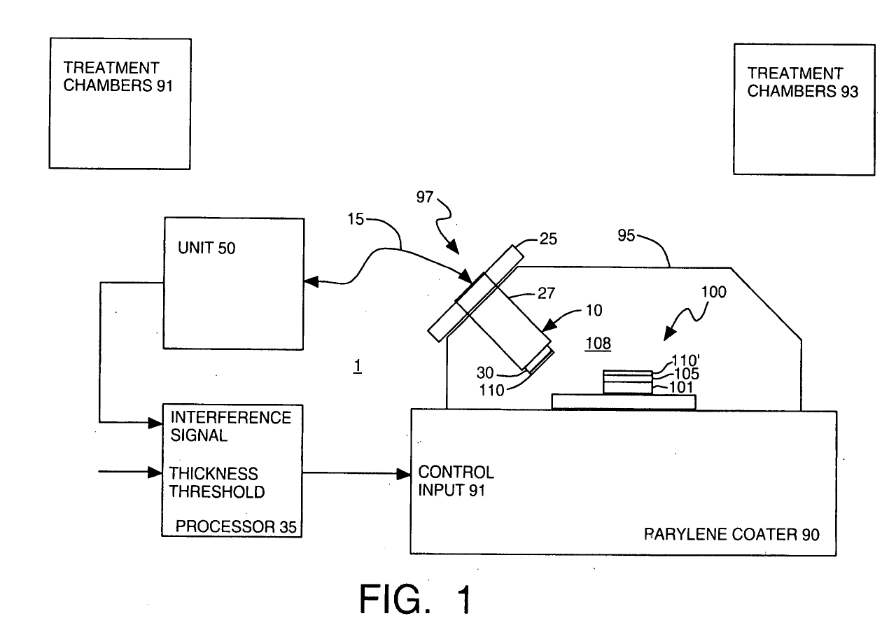

FIG. 1 shows system 1 according to an exemplary embodiment of the present invention. System 1 includes optical film-thickness sensor 10 in coating chamber 95. System 1 employs sensor 10 to measure a deposited film thickness in real time.

Sensor 10 is secured to coating chamber 95 feed-through 97, which is a circular hole. Face plate 30 of sensor 10 holds a cleaved end of optical fiber 15. The other end of optical fiber 15 is coupled to unit 50.

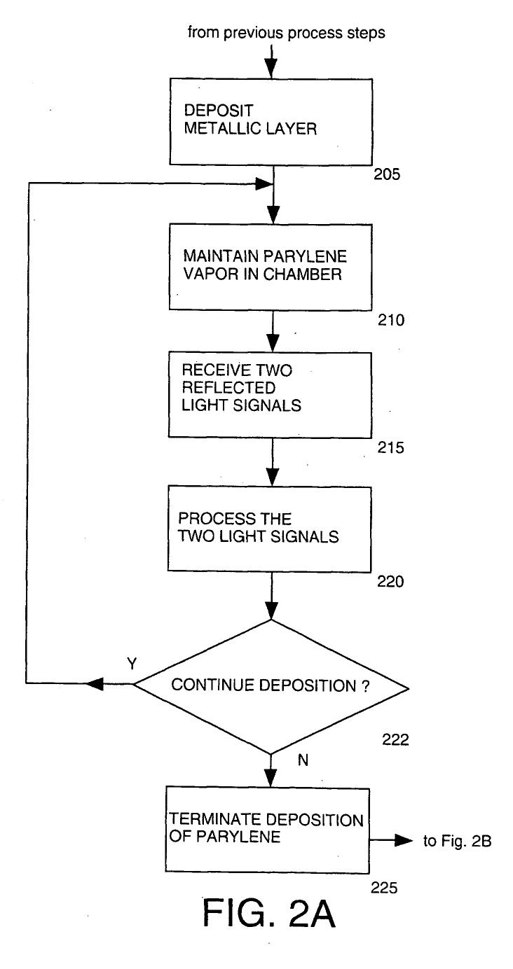

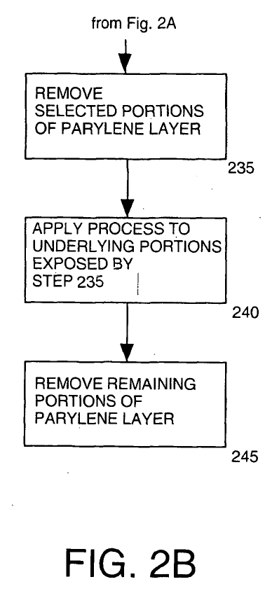

FIGS. 2A and 2B shows a process performed in the exemplary system, to fabricate a device 100. A metallic layer 105 is deposited over substrate 101, in one of treatment chambers 91 (step 205).

The exemplary process then places substrate 101 having layer 105 into chamber 95, and introduces vapor 108 preferably including Parylene into chamber 95.

The exemplary process maintains vapor 108 in chamber 95 containing substrate 101, thereby depositing Parylene layer 110′ over metallic layer 105, and depositing Parylene layer 110 on face plate 30 (step 210).

The exemplary process sends a light signal from unit 50 to sensor 10 via optical fiber 15. As a result of the light signal sent from unit 50, the process receives a light signal reflected at the end of optical fiber 15, and receives a light signal reflected at the interface between layer 110 and the interior of chamber 95. (step 215). The process measures a phase difference between the two reflected light signals. (step 220). Depending on the measurement of step 20, system 1 either continues depositing the Parylene layers 110 and 110′ (step 210), or ceases depositing Parylene layers 110 and 110′ (step 225).

The exemplary process then removes device 100—including substrate 101, layer 105, and layer 110′—from chamber 95. The process selectively etches Parylene layer 110′, in treatment chambers 93, to expose selected portions of metallic layer 105.(step 235). The process preferably patterns Parylene layer 110′ using a silicon shadow mask, and then etches Parylene layer 110′ using an oxygen plasma linear etching system.

The exemplary process applies a chemical processing to the exposed portions of metallic layer 105 (step 240). System 1 removes remaining portions of Parylene layer 110′ (step 245).

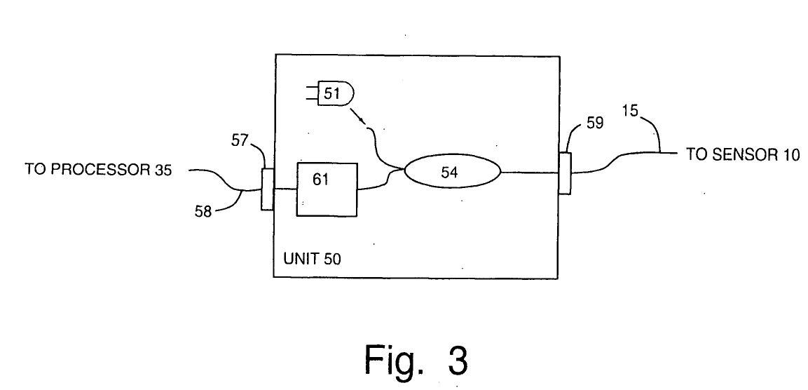

FIG. 3 shows a preferred embodiment of unit 50 in more detail. Light from laser diode 51 passes through coupler 54, to connector 59, to optical fiber 15, to the end of fiber 15. In other words, coupler 54 directs light from LED 51 into fiber 15, and directs light from fiber 15 into photo detector 61, which is a light-to-electrical converter. The signal from the photo detector 61 is then analyzed by circuitry in processor 35.

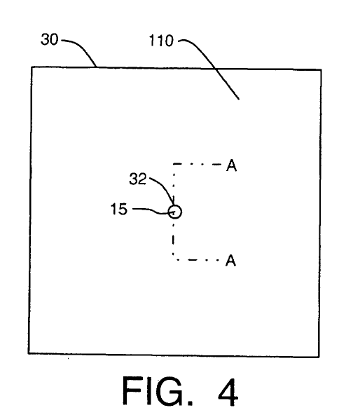

FIG. 4 is a front view of face plate 30, depicting fiber 15 in through hole 32 of plate 30. In one preferred embodiment, plate 30 is 1″ square by 0.125″ thick. Hole 32 is 130 microns in diameter.

Plate 30 preferably is composed of fused silica and has the same polish rate as that of fiber 15.

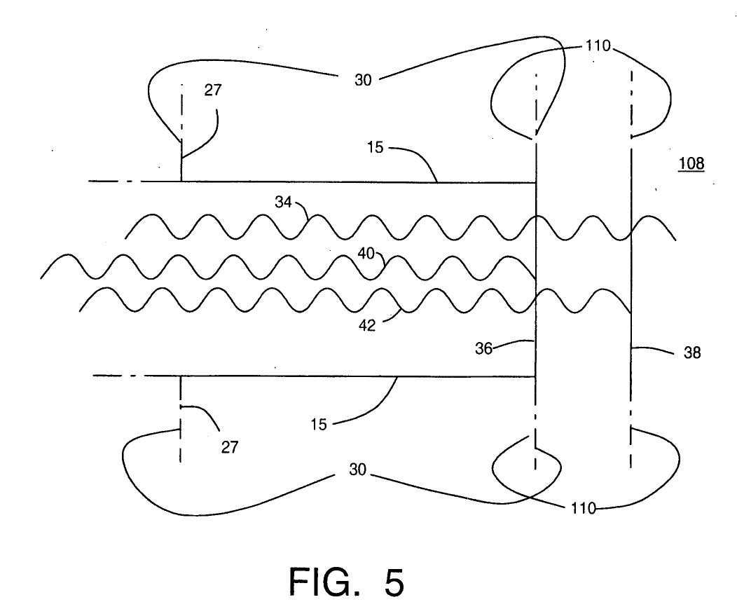

Plate 30 preferably is constructed from slabs of fused silica approximately 1″ square by approximately 1 millimeter thick. Each slab preferably has an approximately 130-micron laser-drilled hole. Fiber 15 is passed through the hole of each slab. Subsequently, the slabs are fused together to form plate 30. One end of fiber 15 preferrably is polished to be flush with a surface of plate 30, as shown at the right side of FIG. 5, promoting a flat and cleaved sensor face for uniform film deposition. The preferred fused silica composition of plate 30 promotes uniform polishing with optical fibers.

FIG. 5 is a side view corresponding to the line A-A shown in FIG. 4. Optical fiber 15, having one end coupled to unit 50, extends through plate 30 to interface 36 between fiber 15 and Parylene layer 110. Thus, part of light signal 34, from LED 51, is reflected from fiber/Parylene interface 36, to form light signal 40. Another part of light signal 34 is reflected from Parylene/air interface 38, to form light signal 42. Signals 40 and 42 go back through fiber 15.

The theory used is that of a Fabry Perot interferometer. Whenever propagating light hits an interface, there is a reflection. Light moves through different media at different speeds. So, as the light exits the fiber, and into a film of depositing material, the light will reflect from the fiber/depositing material interface, and the depositing material/air interface. The light reflecting off the depositing material/air interface travels a longer distance and at a different rate through the polymer than the light reflecting off of the fiber/depositing material interface. The interaction of these signals is interference. Since one signal has traveled further than the other, they are no-longer in phase as they travel through the fiber. As the film gets thicker, the phase difference will change. This phase change can be measured, and as a result the thickness of the film can be calculated. A difference in phase between signals 40 and 42 changes as the thickness of film 110 increases. Photo detector 61 converts interfering signals 40 and 42 into an electrical signal, and sends the electrical signal through connector 57, cable 58, to processor 35. This electrical signal indicates the thickness of film 110 according to Fabry-Perot Interferometer principles.

Processor 35 includes circuitry to receive the interference signal from photo detector 61, process the interference signal, and compare the processed interference signal to a thickness threshold sent to processor 35. As a result of the comparison, processor 35 changes the signal sent to control input 91 of coater 90.

In this patent application, the word circuitry encompasses dedicated hardware, and/or programmable hardware, such as a CPU or reconfigurable logic array, in combination with programming data, such as sequentially fetched CPU instructions or programming data for a reconfigurable array.

The thickness threshold sent to processor 35 may originate from a keyboard, mouse, or other input device in a computer system or may be stored in addressable memory or in a database accessible to processor 35, or other storage devices known to those of skill in the art.

Cylinder 27 of sensor 10 preferably is potted with a polymer fill material to secure fiber 15. Flange 25 of sensor 10 preferably attaches to the standard feed through port on coating chamber 95, allowing plate 30 to be inside chamber 95, and the fiber 15 end to pass through to the outside without compromising the vacuum in chamber 95.

Portions of the jacketed fiber 15 are inside of the potting material for stress relief. The single mode fiber 15 preferably is accompanied by an angled FC-connector, or LC connector for ease of operation.

Installation preferably includes securing of the sensor 10 into the feed-through on the deposition chamber 95. Fiber 15 is coupled with unit 50.

Safety issues with the sensor arise during operation. During this time, basic laser safety standards should be enforced and followed.

Maintenance may include cleaning of the fiber 15 and connectors, and routine inspections of faceplate 30. If necessary, the sensor could be cleaned of trace Parylene in Oxygen plasma.

Additionally, the fiber face may be repolished to maintain the performance and quality of the optical signal. The polish is preferably substantially perpendicular to the fiber coreto avoid attenuation of the optical signal.

Due to the natural air/glass interface, the return fiber 15 should be returning approximately 1% of the returned energy. This 1% is based on the approximately 4% interface reflection and the approximately 25% transfer efficiency of coupler 54. The returned signal from the Parylene/fiber interface is detected by the photo detector 61. Once the film 110 begins to be deposited on the fiber face at plate 30, the base signal changes. As film 110 increases, there is an increasing phase shift between signals 40 and 42. Through Fabry Perot interferometer formulas, this phase change can be used to determine the real time thickness of the deposited polymer film. When the desired film thickness is obtained, processor 35 preferably changes the control input 91 sent to coater 90, to terminate the coating process.

Thus, the exemplary deposition system uses non-invasive and passive optical techniques.

A problem in obtaining precise Parylene films is the many variations of the deposition process that can affect the deposition rate and resulting film thickness. Variations in chamber temperature, chamber pressure, and vapor temperature, to name a few, can all affect the precision of the Parylene film thickness. With some advanced, thin-film applications, these minor variations can-greatly affect the performance of the coated part, as well as the performance of the coating. A characteristic of the sensor 10 is that it is preferably co-located in the coating chamber 95, and the film thickness is optically interrogated, thus generating no temperature or pressure effects to the coating process.

The light reflecting off of the Parylene/Air interface 38 travels a longer distance than the light refection off of the first interface, and also travels at a different rate through the polymer. The interaction between signals 40 and 42 is interference, corresponding to a phase change. As film 110 gets thicker, this phase difference changes. This phase change, knowing the properties of the light and of the Parylene, can be measured, and as a result the thickness of the film is calculated.

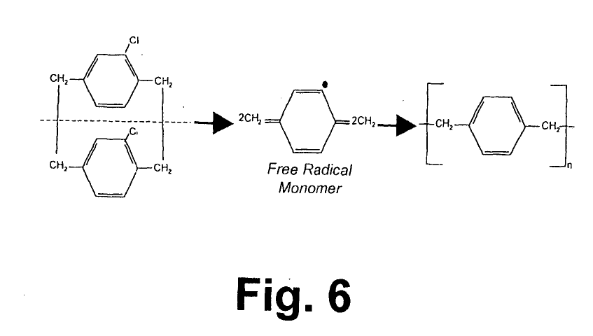

FIG. 6 is a schematic diagram representing the process of depositing Parylene C in step 210 above.

In other words, exemplary system 1 includes chamber 95, fiber 15, interface 36 in chamber 95, and unit 50 and processor 35 configured to process light reflected from interface 36. A Coater 90, is responsive to an output of processor 35.

Chamber 95 defines a circular opening 97. Sensor 10 is removably attached to chamber 95 through opening 97. Fiber 15 extends from layer 110 through plate 30, through cylinder 27, and through flange 25. Thus fiber 15 extends through opening 97, from the interior of chamber 95 to the exterior of chamber 95.

Flange 25 and cylinder 27 form a seal at opening 97, allowing a pressure in the chamber 95 to be lower than an ambient pressure.

In summary, the exemplary system acts to deposit metallic layer 105 over substrate 101, and deposit Parylene layer 110′ over layer 105. Concurrently with the deposition of layer 110′, the exemplary system acts to deposit layer 110 on plate 30, which does not have layer 105. Unit 20 and processor 35 act to process a light signal reflected from layer 110, and conditionally terminate depositing, depending on the processing.

During deposition, plate 30, metal layer 105, and substrate 101 are preferably at a substantially common temperature in chamber 95.

There are numerous variations on the exemplary systems described above. The entire system could comprise merely a sensor head. Conversely, the entire analysis could be performed inside of the control box, with a graphical output of the measured film thickness. To improve resolution, the number of fibers could be increased. Furthermore, the end of the probe head could be adjustable to maneuver the probe face within the chamber.

The application of Parylene in the exemplary system may be used with a wide variety of materials, including Cr/Au, Al, Si₃N₄, Si0₂, and all subsequent etchants used in their processing.

Parylene coater 90 may be the Paratronix Model 1293 Parylene deposition system.

Although the exemplary system employs Parylene as a masking layer to protect underlying materials and structures, materials other than Parylene may be employed, and the application of such materials is not limited to mask layers. For example, the exemplary system may measure the deposited thickness of structural layers to create out-of-plane microstructures, etch-stops, seed layers, or any combination of the above.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

1. A method for a thin film fabricating system including a first substrate, a first layer, and a second substrate, the method comprising:
depositing a second layer over the first substrate and the second substrate;
receiving a light signal from the second layer on the second substrate; and
processing the light signal.

2. The method of claim 1 further including conditionally terminating the depositing of the second layer on the first substrate, depending on a result of the signal processing step.

3. The method of claim 1 wherein the first and second substrates are at a substantially common temperature.

4. The method of claim 1 wherein the system includes a chamber and the first and second substrates are in the chamber during the steps of depositing the second layer.

5. The method of claim 4 wherein the light signal passes through an optical conduit directing light into the chamber.

6. The method of claim 4 wherein the first substrate is outside the chamber during the step of depositing the first layer.

7. The method of claim 1 further including selectively removing a portion of the second layer from the first substrate, to expose a portion of the first layer; and subjecting the exposed first layer to a chemical treatment.

8. The method of claim 7 further including subsequently removing remaining portions of the second layer.

9. The method of claim 1 wherein the second layer includes Parylene.

10. The method of claim 9 wherein the first layer includes metal.

11. The method of claim 10 wherein said metal includes a member selected from the group consisting of gold, chromium, silicon nitrate and silicon oxide.

12. A thin film fabrication system for use with a chamber, the system comprising an optical conduit;
a surface, in the chamber, oriented to receive light from the optical conduit;
a detector configured to process a light signal reflected from the surface; and
a depositor that deposits a material on said surface, the depositor being responsive to an output of the detector.

13. The system of claim 12 wherein the chamber defines an opening, and the system further includes a housing removably attached to the chamber through the opening, the optical conduit passing through the housing.

14. The system of claim 13 wherein the housing forms a seal at the opening, allowing a pressure in the chamber to be lower than an ambient pressure.

15. The system of claim 12 further including a member defining the surface, and defining a through-hole, wherein the optical conduit includes an optical fiber in the through-hole.

16. The system of claim 15 wherein the member includes a plate defining the surface.

17. The system of claim 12 wherein the optical conduit passes from the exterior to the interior of the chamber.

18. The system of claim 12 wherein the detector receives the reflected light signal via the optical conduit.

19. A deposition system including a first substrate having a first layer, the deposition system comprising:
a second substrate;
a depositor for depositing a second layer on the first and second substrates;
an optical conduit for receiving a light signal from the second layer on the second substrate;
a processor for processing said light signal; and
a control input for conditionally terminating depositing the second layer depending on a signal from the processor.

20. The deposition system of claim 19 further including a chamber that maintains the first and second substrates at substantially common temperature.

21. The deposition system of claim 19 further including a chamber that contains the first and second substrates during activation of the depositor.

22. The deposition system of claim 21 wherein the optical conduit directs the light signal from the interior of the chamber to the exterior of the chamber.

23. The deposition system of claim 19 further including a depositor that deposits the first layer on the first substrate.

24. The deposition system of claim 19 further including a remover that selectively removes a portion of the second layer from the first substrate, to expose a portion of the first layer, and subject the portion of said first layer to a chemical treatment.

25. The deposition system of claim 19 wherein the second layer includes Parylene.
